(19) United States
(12) Patent Application Publication
(10) Pub. No.: US 2018/0269710 A1
(43) Pub. Date: Sep. 20, 2018

(54) POWER TRANSMITTER COIL IN WIRELESS CHARGING SYSTEM

(71) Applicant: Shenzhen Yichong Wireless Power Technology Co. Ltd., Shenzhen (CN)

(72) Inventors: Xiaojun Peng, Chengdu (CN); Siming Pan, San Jose, CA (US); Tun Li, San Jose, CA (US); Dawei He, Burlingame, CA (US)

(21) Appl. No.: 15/490,406

(22) Filed: Apr. 18, 2017

Related U.S. Application Data
(60) Provisional application No. 62/472,325, filed on Mar. 16, 2017.

(51) Int. Cl. H02J 7/02; H02J 50/10; H02J 50/90; H01F 27/28; H01F 27/29; H01F 38/14

(52) U.S. Cl. CPC H02J 7/025; H02J 50/10; H01F 38/14; H01F 27/2823; H01F 27/29; H02J 50/90

(57) ABSTRACT

A design of a power transmitter coil for a wireless charging system is disclosed. The power transmitter coil may include a square-shaped coil and two terminals. The two terminals may be extended from the coil. The coil may be routed by a wire in a plane.

### CROSS-REFERENCE TO RELATED APPLICATIONS

This application claims the benefit of U.S. Provisional Application Ser. No. 62/472,325, filed Mar. 16, 2017, and entitled “POWER TRANSMITTER COIL IN WIRELESS CHARGING SYSTEM”. The entirety of the aforementioned application is incorporated herein by reference.

### TECHNICAL FIELD

The disclosure relates generally to a wireless charging system, particularly, to a design of a power transmitter coil in the system.

### BACKGROUND

Wireless charging is an evolving technology that may bring a new level of convenience of charging electronic devices. In a wireless charging system, particularly an inductive wireless charging system, energy is transferred from one or more power transmitter (TX) coils to one or more power receiver (RX) coils through magnetic coupling.

In a general wireless charging system, the input power is delivered from a power transmitter to a power receiver through two or more coupled magnetic coils. The magnetic coupled coils include the power transmitter coils and power receiver coils. Conventional wireless charging systems usually have a very limited charging area and require a RX device be aligned with a TX device while charging.

To improve user experiences and broaden wireless charging applications, it is desirable to design a wireless charging system to cover a large charging area with a high charging efficiency. This disclosure proposes a design of a TX coil to achieve a large uniform charging area with a high charging efficiency in a wireless charging system.

### SUMMARY

The present disclosure is directed to a power transmitter coil for a wireless charging system. The power transmitter coil may include a square-shaped coil and two terminals. The two terminals extend from the coil. The coil may be routed by a wire in a plane.

Another aspect of this disclosure is directed to a wireless charging system. The system may include a power transmitter and a power receiver. The power transmitter may include one or more power transmitter coils. The power transmitter coils may be coupled to one or more power receiver coils. The power receiver may include one or more power receiver coils, and may be configured to wirelessly charge a device. The one or more power transmitter coils may include a square-shaped coil routed by a wire in a plane.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several non-limiting embodiments and, together with the description, serve to explain the disclosed principles.

FIG. 1 is a block diagram illustrating a wireless charging system, consistent with exemplary embodiments of the present disclosure.

FIGS. 2(a)-2(b) are graphical representations illustrating a top view of a power transmitter coil, consistent with exemplary embodiments of the present disclosure.

FIGS. 3(a)-3(b) are graphical representations illustrating a side view of a power transmitter coil, consistent with exemplary embodiments of the present disclosure.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

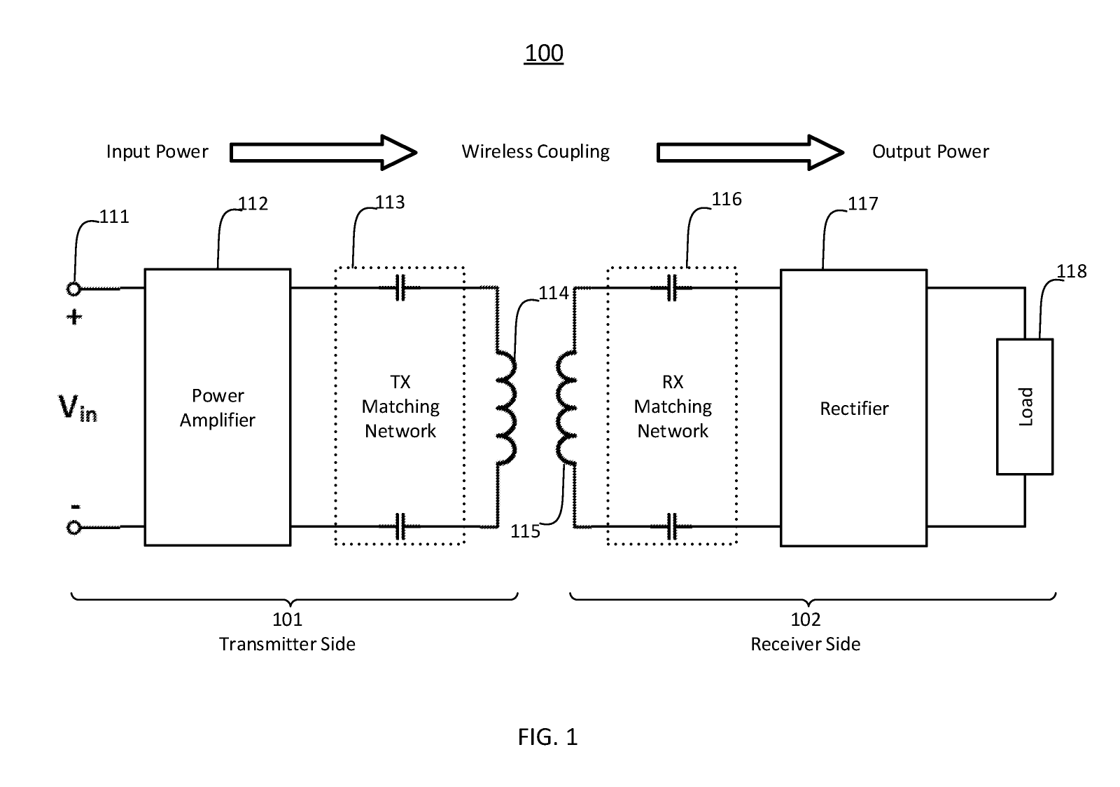

FIG. 1 is a block diagram illustrating a wireless charging system 100, consistent with exemplary embodiments of the present disclosure. The system 100 may comprise a number of components, some of which may be optional. In some embodiments, the system 100 may include many more components than those shown in FIG. 1. However, it is not necessary that all of these components be shown in order to disclose an illustrative embodiment.

The system 100 may include a transmitter side 101 and a receiver side 102. The transmitter side 101 may include power input nodes (+and −) 111, a power amplifier 112, and a power transmitter. The power transmitter may include a TX matching network 113, and one or more TX coils 114. The receiver side 102 may include a power receiver, a rectifier 117, and a load 118 of a RX device. The power receiver may include one or more RX coils 115 and a RX matching network 116. The load 118 can be a battery of a device to be charged. The device can be a mobile device, a wearable device, a tablet device, a computer, a car, or any device that includes a chargeable battery. The one or more RX coils can be coupled to the device. The power input nodes 111 may be coupled to the power amplifier 112. The power amplifier 112 may be coupled to the TX matching network 113. The TX matching network 113 may be coupled to one or more TX coils 114. The TX matching network 113 may include one or more capacitors. Capacitance of one or more of the capacitors may be adjustable. The TX matching network 113 and the TX coil(s) 114 may form a resonant circuit or an LC circuit where the L represents the TX coil(s) and C represents the capacitor connected together. The frequency of the LC circuit can be adjusted by adjusting the capacitance of the TX matching network 113. The TX coil(s) 114 may be coupled with one or more RX coils 115 via a magnetic coupling. In the receiver side 102, the RX coil(s) 115 may be coupled to the RX matching network 116, the RX matching network 116 may be coupled to the rectifier 117, and the rectifier 117 may be coupled to the load 118. The RX matching network 116 may include one or more capacitors. One or more capacitors may have adjustable capacitance. The capacitors may be used to adjust the frequency of an LC circuit formed by the RX coil(s) 115 and the RX matching network 116. Accordingly, the resonant frequency of the LC circuit can be determined by tuning the capacitance of the capacitors. The TX matching network 113, TX coil(s) 114, RX coil(s) 115 and RX matching network 116 form a coil-to-coil sub-system 103.

In one embodiment, an input voltage is converted from a DC power to an AC power and amplified by the power amplifier 112. Then the power is transmitted from the transmitter side 101 to the receiver side 102 through two or more coupled coils. The AC voltage received at the receiver side 102 is regulated back to a DC voltage by the rectifier 117 and then delivered to the load 118.

A TX coil can be designed to achieve a large effective charging area while minimizing the physical dimension of the coil by changing its parameters. The effective charging area of a set of TX and RX coils is defined as a charging area of RX coil placement with regard to the TX coil, where if the center of the RX coil is placed inside the charging area, a coil-to-coil efficiency between the coils should be no less than a desired value (e.g., a value desired or pre-determined by a user). The effective charging area may be on a horizontal plane that is parallel to the TX coil. For example, the effective charging area may be on the same plane as the TX coil. “Horizontal” may refer to a direction that is parallel to the plane of a TX or RX coil, while “vertical” may refer to a direction that is perpendicular to the plane. A radius of the effective charging area may be defined as the horizontal distance between the center of a TX coil (e.g., a vertical projection of the center on the horizontal plane where the effective charging area resides) and the boundary of the effective charging area. In some embodiments, the distance between the TX and RX coils may vary from 0-10 mm. The parameters of a TX coil may refer to a coil shape, turn number, outer diameter, inner diameter, etc. Based on simulations and experiments, these parameters can be tuned to optimize a coil-to-coil efficiency. A coil-to-coil efficiency refers to the efficiency between a TX coil and a RX coil. It is calculated by the ratio of a RX coil output power (e.g., alternating current (AC) power) over a TX coil input power (e.g., AC power). The loss that affects the coil-to-coil efficiency includes the conductor loss in the coils, the parasitic resistance loss of the TX and RX matching capacitors, and other losses.

Values of the parameters for an exemplary TX coil design are presented in Table 1. Small variations of the values should be considered as within the scope of the structure and design in this disclosure. Potential variation ranges are also presented in Table 1. The number of turns in a coil may be 5. The coil may have a square shape with an outer diameter of 50 mm and an inner diameter of 37.5 mm. The wire may be made of copper with insulation wrapping, which has an overall diameter of 1.2 mm. The edge-to-edge spacing between adjacent turns of the insulated wire may be 0 mm. The coil may be made of a Litz wire. This particular TX coil design can achieve a uniform effective charging area with no less than 90% of coil-to-coil efficiency within a circular effective charging area, which has a radius of no less than 20 mm. Also at the center of the TX coil, the coil-to-coil efficiency is no less than 95% of peak coil-to-coil efficiency. The peak coil-to-coil efficiency is defined as the coil-to-coil efficiency when the centers of a RX coil and a TX coil are aligned.

TABLE 1

| Parameter | Symbol | Value | | Variation Range |
|---|---|---|---|---|
| Turn Number | N | 5 | | 4-6 |
| Coil Shape | / | Square | | Corners may be |
| | | | | rounded |
| Outer Diameter | OD | 50 | mm | ±2 mm |
| Inner Diameter | ID | 37.5 | mm | ±2 mm |
| Space between Turns | S | 0 | mm | / |
| Coil Type | / | Litz Wire | | / |
| Wire Trace Material | / | Copper Strands | | Similar Material |
| Wire Overall Diameter | D | 1.2 | mm | ±0.15 mm |

In some embodiments, the TX coil may have an outer diameter of 48-52 mm and an inner diameter of 35.5-39.5 mm. The TX coil may include 4-6 turns of wire. The wire may be made of copper with an overall diameter including insulation of 1.05-1.35 mm.

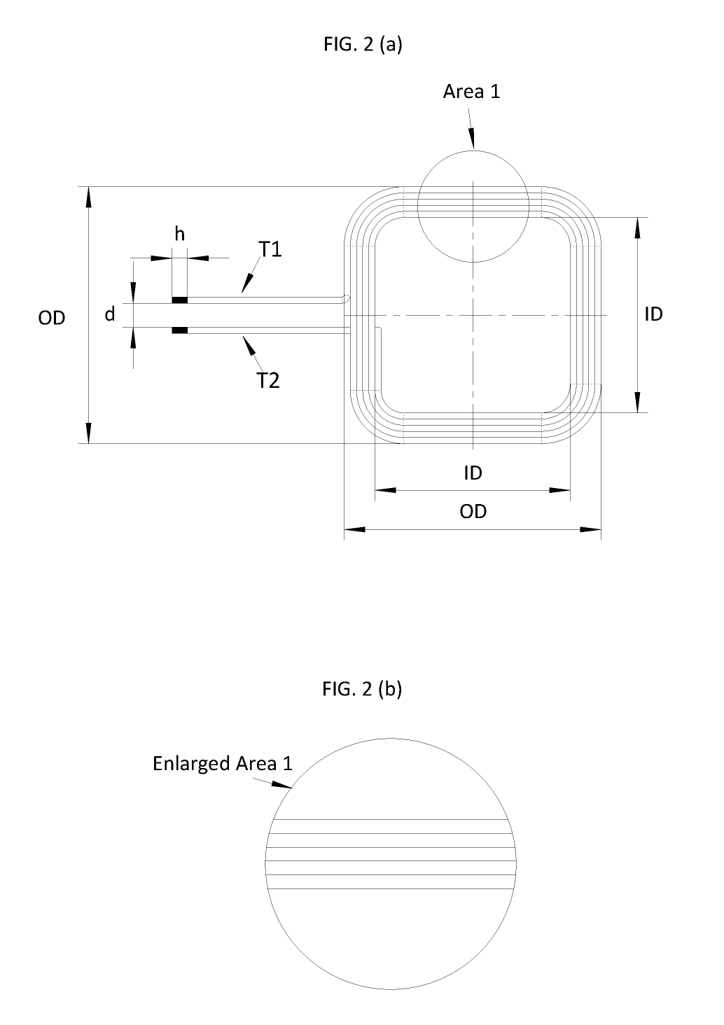

FIG. 2(a) is a graphical representation illustrating a top view of an exemplary TX coil. As shown in FIG. 2(a), a wire is routed into a square shaped coil, with two extending terminals. The corners of the square shaped coil may be rounded. The inner diameter of the TX coil is denoted as ID and the outer diameter of the TX coil is denoted as OD. The two terminals with their ends having a length of h (e.g., 3 mm), are separated with a distance of d (e.g., 5 mm). To have a clear view of the TX coil, Area 1 is selected and enlarged in FIG. 2(b). In one embodiment, the wire has a trace diameter of D, and the insulated wire is closely routed with no spacing between the turns. In this exemplary design, the TX coil contains 5 turns of wire.

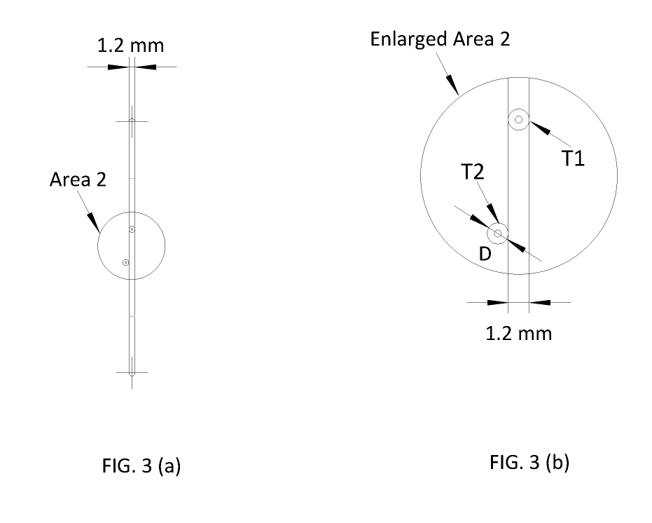

FIG. 3(a)is a graphical representation illustrating a side view of an exemplary TX coil. The TX coil is viewed from the two terminals towards the coil. The two circles represent the cross-sections of the two extending terminals, and the rod-like shape illustrates the side view of the TX coil. As shown in FIG. 3(a), the thickness of the coil equals to 1.2 mm, which is the same as the overall diameter of the wire. The wire is closely routed into a coil in the same plane. To have a clear view of the locations of the terminals, Area 2 is selected and enlarged in FIG. 3(b). Both terminals have an overall diameter of D. One of the terminal (T1) locates in the same plane as the coil, and the other terminal (T2) locates closely contacting with the plane.

The invention described and claimed herein is not to be limited in scope by the specific preferred embodiments disclosed herein, as these embodiments are intended as illustrations of several aspects of the invention. Indeed, various modifications of the invention in addition to those shown and described herein will become apparent to those skilled in the art from the foregoing description. Such modifications are also intended to fall within the scope of the appended claims.

What is claimed is:

1. A power transmitter coil for a wireless charging system, comprising:
a square-shaped coil routed by a wire in a plane; and
two terminals extending from the coil.

2. The power transmitter coil of claim 1, wherein the coil has an outer diameter of 48-52 mm.

3. The power transmitter coil of claim 1, wherein the coil has an inner diameter of 35.5-39.5 mm.

4. The power transmitter coil of claim 1, wherein the coil has 4-6 turns of wire.

5. The power transmitter coil of claim 1, wherein the wire of the coil is closely routed with no spacing between adjacent turns.

6. The power transmitter coil of claim 1, wherein a coil type of the wire is Litz wire.

7. The power transmitter coil of claim 1, wherein the wire is made of copper with insulation wrapping and has an overall diameter of 1.05-1.35 mm.

8. The power transmitter coil of claim 1, wherein the lengths of the two terminal ends are 3 mm, and the two terminals are spaced with a distance of 5 mm.

9. The power transmitter coil of claim 1, wherein one terminal locates in the plane of the coil, and the other terminal locates closely contacting with plane of the coil.

10. The power transmitter coil of claim 1, wherein corners of the coil are rounded.

11. A wireless charging system, comprising:
a power transmitter configured to receive an input power, the power transmitter comprising one or more power transmitter coils wirelessly coupled to one or more power receiver coils; and
a power receiver comprising the one or more power receiver coils and configured to charge a device, wherein:
the one or more power transmitter coils include a square-shaped coil routed by a wire in a plane.

12. The system of claim 11, wherein the one or more power transmitter coils have an outer diameter of 48-52 mm.

13. The system of claim 11, wherein the one or more power transmitter coils have an inner diameter of 35.5-39.5 mm.

14. The system of claim 11, wherein the one or more power transmitter coils have 4-6 turns of wire.

15. The system of claim 11, wherein the wire is closely routed with no spacing between adjacent turns.

16. The system of claim 11, wherein the wire is a Litz wire.

17. The system of claim 11, wherein the wire is made of copper with insulation wrapping and has an overall diameter of 1.05-1.35 mm.

18. The system of claim 11, wherein the lengths of the two terminal ends are 3 mm, and the two terminals are spaced with a distance of 5 mm.

19. The system of claim 11, wherein one terminal locates in the plane, and the other terminal locates closely contacting with plane.

20. The system of claim 11, wherein corners of the one or more power transmitter coils are rounded.
